(19) United States
(12) Patent Application Publication
(10) Pub. No.: US 2001/0044754 A1
(43) Pub. Date: Nov. 22, 2001

(54) Information providing system, information providing method, and display control method

(75) Inventors: Masato Fujii, Nagaokakyo-Shi (JP); Hideki Nagata, Kobe-Shi (JP); Takehisa Yamaguchi, Ikoma-Shi (JP); Yasumasa Sawai, Yamatotakada-Shi (JP); Akira Kawabata, Ikoma-Shi (JP)

Correspondence Address: MCDERMOTT, WILL & EMERY, 600 13th Street, N.W., Washington, DC, 20005-3096, US

(73) Assignee: MINOLTA CO., LTD

(21) Appl. No.: 09/852,844

(22) Filed: May 11, 2001

(30) Foreign Application Priority Data
May 22, 2000 (JP) 2000-150070

(51) Int. Cl. G06F 17/60

(52) U.S. Cl. 705/26

(57) ABSTRACT

An object of the present invention is to easily search for shops having delivery areas including user terminals. When two users access a shop search site of a server by use of user terminals (step S1), the same contents are displayed on both of the user terminals in the following processing: One of the users is set as the merchandise purchaser (step S2), the position information of the other user, the merchandise receiver, is transmitted to the server (step S3), and the desired shop kind is set by one of the users (step S4). Then, shops of the shop kind the delivery areas of which include the receiver are retrieved and displayed.

### RELATED APPLICATION

This application is based on application No. 2000-150070 filed in Japan, the entire content of which is hereby incorporated by reference.

### BACKGROUND OF THE INVENTION

1. Field of the Invention

The present invention relates to an information providing system, an information providing method, and a display control method for providing a communication terminal with information on a shop through communication, and more specifically, to a system, a method and a display control method for providing shop information by searching for a shop through a server that can be connected to user terminals possessed by users so that communication can be performed between the server and the user terminals.

2. Description of the Related Art

With the popularization of the Internet, various shops have recently set up Web sites introducing merchandise they handle. In addition, online shopping where merchandise can be purchased by selecting a product, performing a predetermined procedure and making a payment by electronic banking on a Web site has been becoming popular. This enables consumers to readily purchase desired products at their homes by accessing Web sites.

In such online shopping, although it usually takes several days to several weeks to make delivery via courier service or by a delivery company, there are shops that can make delivery within approximately 30 minutes or one hour within a predetermined delivery area from the actual shops. In actuality, however, consumers cannot easily find Web sites of shops satisfying predetermined delivery conditions such that delivery can be made to the customer's home within a predetermined time.

### SUMMARY OF THE INVENTION

An object of the present invention is to solve the above-mentioned problem of the prior art.

Another object of the present invention is to provide a shop search system, a shop search method and a display control method by which shops having delivery areas including user terminals can be easily searched for.

These and other objects are attained by a system for providing a communication terminals with information on a shop through communication, said method comprising: a first storage portion for storing data of a plurality of shops, said data of the shops including delivery area information on delivery areas of the shops; an acquisition portion that acquires first location information on a location of a first communication terminal; a processing portion for searching for a shop a delivery area of which includes the location of the first communication terminal based on the stored delivery area information and the received first location information; and a transmission portion for transmitting a result of the search by the processing portion to the first communication terminal.

Moreover, the above-mentioned objects of the present invention are attained by a method for providing a communication terminal with information on a shop through communication by use of a system in which data of a plurality of shops including delivery area information on delivery areas of the shops is previously stored, said information providing method comprising the steps of: acquiring location information on a location of the communication terminal; based on the delivery area information of the shops and the received location information, searching for a shop a delivery area of which includes the location; and transmitting a result of the search by a processing portion to a first communication terminal.

Moreover, the above-mentioned objects of the present invention are attained by a display control method in which a server to which a first communication terminal and a second communication terminal are connected so that communication can be performed between the server and the terminals controls at least a display portion of the first communication terminal, said display control method comprising the steps of: receiving an instruction from the second communication terminal; receiving first information from the first communication terminal in response to reception of the instruction; processing data stored in the server based on the received first information; and transmitting the processed data at least to the first communication terminal, wherein the first communication terminal displays the received information on the display portion thereof in response to reception of the processed data.

The invention itself, together with further objects and attendant advantages, will best be understood by reference to the following detailed description taken in conjunction with the accompanying drawings.

### BRIEF DESCRIPTION OF THE DRAWINGS

FIG. 1 is a block diagram showing the system configuration and the functions of portions of a shop search system according to an embodiment of the present invention;

FIG. 2 is a block diagram of a server;

FIG. 3 is a block diagram of a user terminal;

FIG. 4 is a flowchart of a shop search processing;

FIG. 5 shows an example of a user access method;

FIG. 6 shows another example of the user access method;

FIG. 7 shows the Web site of a shop search site and a manner of choosing a purchaser;

FIG. 8 is a flowchart of a non-chain-store-type shop search processing;

FIG. 9 shows the data format of a shop information database;

FIG. 10 schematically shows the delivery areas of shops in neighboring areas of both users;

FIGS. 11(a) and 11(b) show narrowed search result screens;

FIGS. 12(a) and 12(b) show narrowed search result screens in a case where the search is further narrowed;

FIG. 13 shows details of the delivery areas of the shops in neighboring areas of a user U1 of FIG. 10;

FIG. 14 shows the Web site of a shop;

FIG. 15 is a flowchart of a chain store search processing;

FIG. 16 schematically shows the delivery areas of shops of a common chain in neighboring areas of both user terminals; and

FIG. 17 shows a modification of a user terminal screen in online shopping.

In the following description, like parts are designated by like reference numbers throughout the several drawings.

### DESCRIPTION OF THE PREFERRED EMBODIMENT

Hereinafter, an embodiment of the present invention will be described with reference to the drawings.

<1. System Configuration>

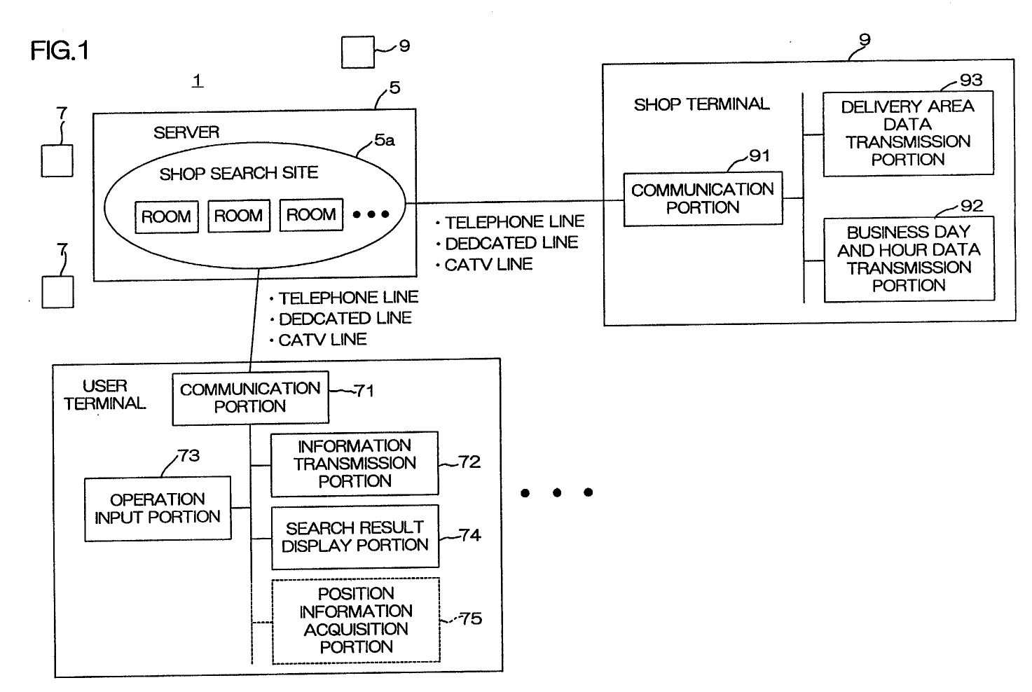

FIG. 1 is a block diagram showing the system configuration and the functions of portions of a shop search system 1 according to the embodiment of the present invention.

As shown in FIG. 1, the shop search system is a computer network system in which a user terminal 7 and a shop terminal 9 are connected to a server 5 through a communication line. The user, a merchandise purchaser, can search for a shop from which he purchases a desired product, by accessing the server 5 from the user terminal 7 and performing a predetermined operation.

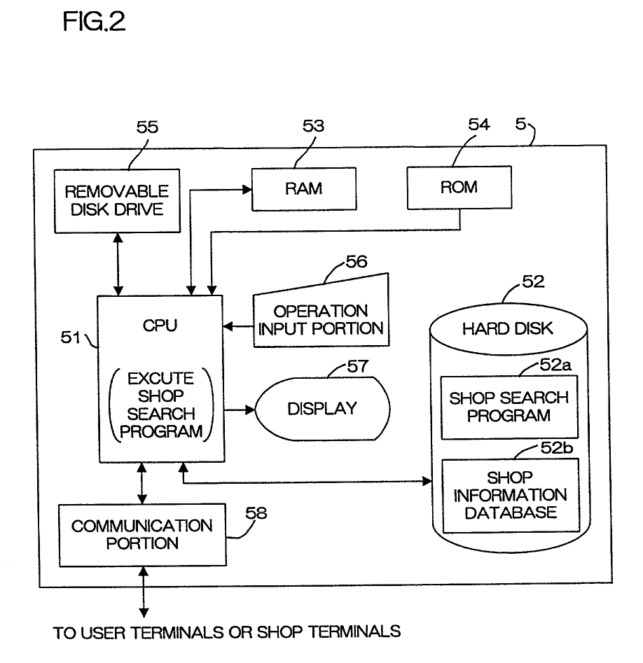

In the server 5, a program and data constituting a shop search site (Web site) 5a are stored in a hard disk 52. In the server 5, as shown in FIG. 2 which is a block diagram thereof, mainly a central processing unit (CPU) 51, the hard disk 52, a random access memory (RAM) 53, a read only memory (ROM) 54, a removable disk drive 55, an operation input portion 56 including a keyboard and a mouse, a display 57, and a communication portion 58 are connected by bus lines. The server 5 is provided with a communication function by this configuration. The CPU 51 reads the shop search program 52a stored in the hard disk 52, and stores it into the RAM 53. The program is read out as required and executed to thereby make a shop search described later. In the shop search, a shop information database 52b stored in the hard disk 52 is referred to.

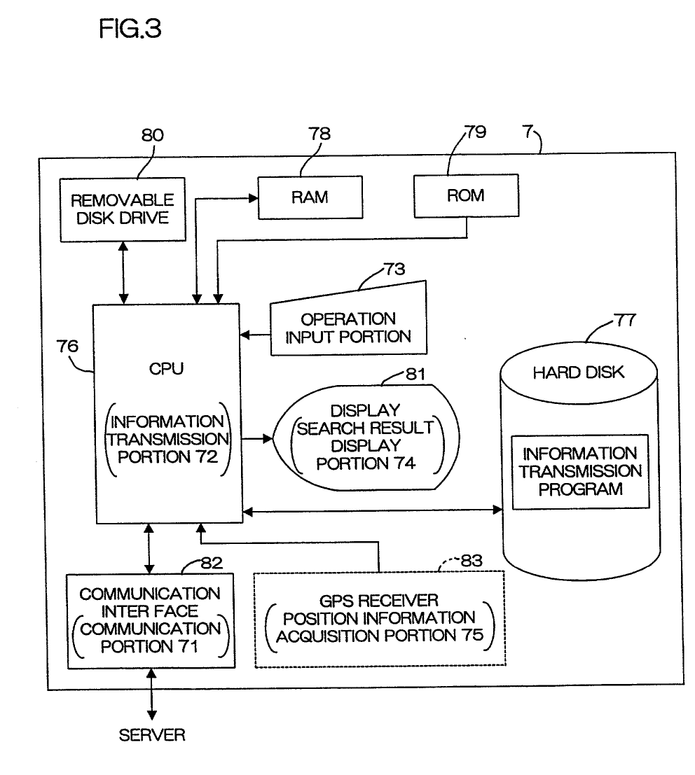

FIG. 3 is a block diagram of the user terminal 7. In this figure, some portions are also denoted by functional blocks of the user terminal 7 shown in FIG. 1. As shown in FIG. 3, a user information transmission program, data and the like are stored in a hard disk 77 also in the user terminal 7. In the user terminal 7, a CPU 76, the hard disk 77, a RAM 78, a ROM 79, a removable disk drive 80, an operation input portion 73 including a keyboard and a mouse, and a display 81 functioning as a search result display portion 74 are connected by bus lines. The CPU 76 mainly functions as an information transmission portion 72 by executing the information transmission program, and performs various data processings. In the user terminal 7, a communication interface (I/F) 82 functioning as a communication portion 71 is further connected by a bus line.

The user terminal 7 is provided with a communication function by this configuration. This communication function enables the user terminal 7 to be connected to the shop search site of the server 5 through the communication portion 71. The information transmission portion 72 transmits setting information such as purchaser information described later and information such as the position information of the user terminal. The user inputs a search criterion or the like from the operation input portion 73. The user terminal 7 functions as an information processing terminal capable of displaying a shop search result screen from the server 5 by the search result display portion 74.

As the user terminal 7, for example, a personal computer, a personal digital assistant (PDA) or a portable telephone can be used as an information processing terminal. When communication is performed via the Internet, the user terminal 7 is connected to a provider through a line such as a telephone line, a dedicated line or a community antenna television (CATV) line, and the provider and the server 5 are connected by a dedicated line.

As described later, when the user terminal 7 is a portable terminal such as a PDA or a portable telephone, the user terminal 7 has a global positioning system (GPS) receiver 84 as a position information acquisition portion 75, and acquires the position information of the user terminal 7 with the GPS receiver 84.

The shop terminal 9 is also a computer having a communication function. The shop terminal 9 can be connected to the server 5 through a communication portion 91. The shop terminal 9 is capable of transmitting the up-to-date business day and hour data to the server 5 by a business day and hour data transmission portion 92 and of transmitting delivery area data on the up-to-data delivery area by a delivery area data transmission portion 93.

When communication is performed via the Internet, the shop terminal 9 is connected to a provider through a line such as a telephone line, a dedicated line or a CATV line, and the provider and the server 5 are connected by a dedicated line.

<2. Shop Search Processing>

The shop search processing in this embodiment will be described by using as an example a case where two persons, for example a couple of a man and a woman, at locations remote from each other are the users. Here, the two persons are registered with the search site. The two persons can purchase desired products on the site of a shop at locations remote from each other by accessing the site of the shop from their user terminals 7.

In purchasing a product, the users transmit the position information and a product kind criterion to the server 5. The server 5 searches the shops stored therein based on the transmitted information, and transmits a shop list to both of the user terminals 7 for the user terminals 7 to display it. Then, the users can enjoy a so-called virtual date such that one user gives a product handled by the shop they are in to the other user as a gift or that the users have the same product delivered to each of them.

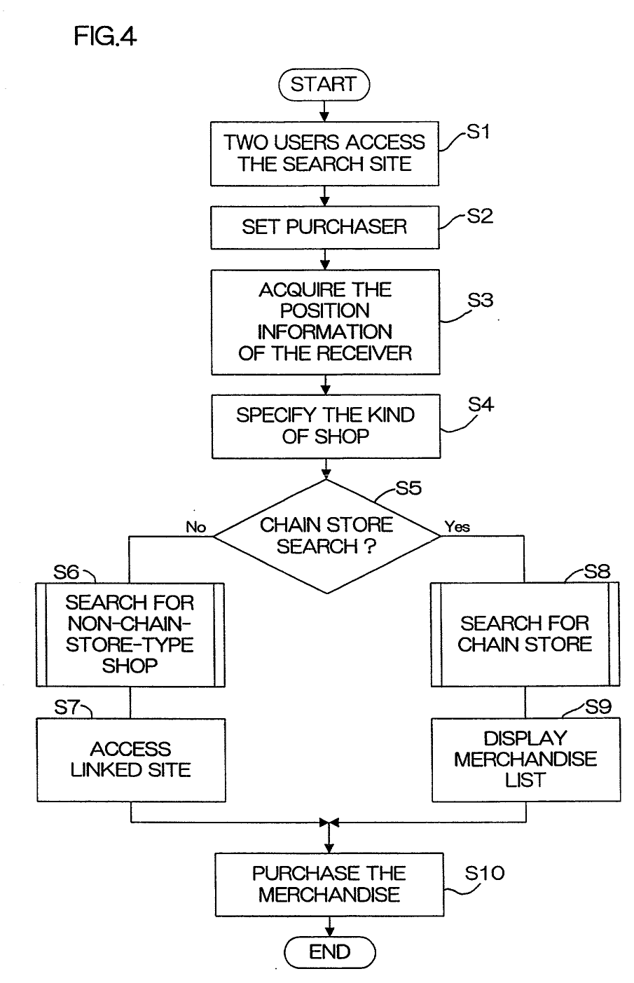

The shop search processing will be described in detail. FIG. 4 is a flowchart of the shop search processing. Unless otherwise specified, the control of portions in the processing described below is performed by the CPU 51 of the server 5 executing the shop search program.

First, the two users access the search site (step S1 of FIG. 4). FIG. 5 shows an example of the user access method. In this access example, one user U1 previously makes contact with the other user U2 by telephone or the like, and the users U1 and U2 access the shop search site 5a by prior consent. As site information on which site the user U1 is accessing, access information of the user U1 is transmitted to the user U2 by electronic mail or the like. The user U2 accesses the site based on the transmitted information. The operation information (a search criterion or the like) of the user U1 or U2 may be automatically exchanged.

The shop search site 5a is provided with a plurality of sites called rooms that can be each accessed only by a pair of users. After accessing a specific room of the search site, the user U1 sets on the shop search site 5a a password for identifying the other user U2. The user U2 can enter the room by inputting the password which the user U2 has been informed of by some means, from the operation input portion 73 of the user terminal 7 and transmitting it to the server 5. No one can enter the room without inputting a password.

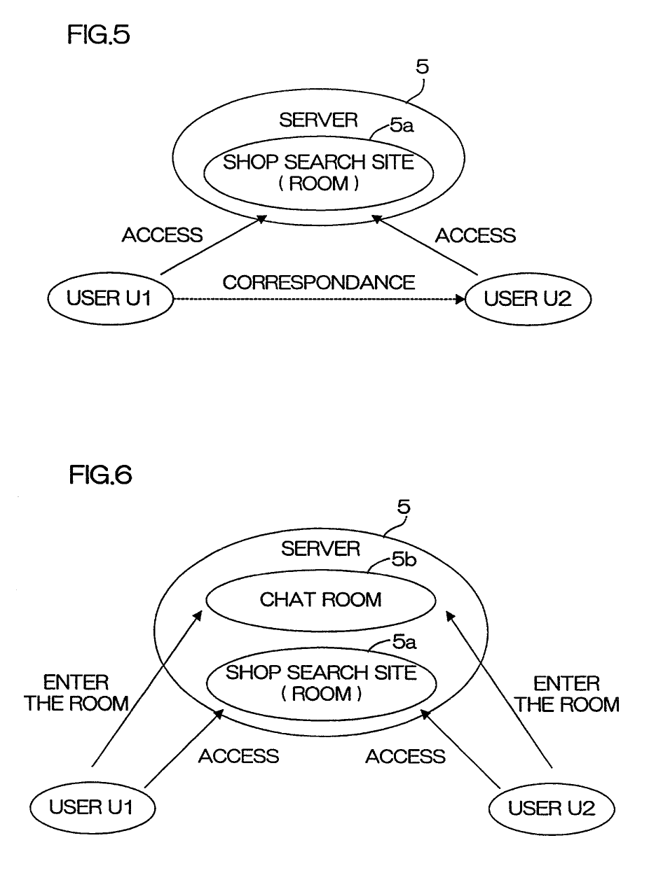

FIG. 6 shows another example of the user access method. In this example, the users U1 and U2 are chatting on an open-to-public chat room 5b different from the shop search site 5a. Then, during the chat, the users U1 and U2 access a specific room of the shop search site 5a by prior consent. In this case, a password is predetermined during the chat. After one user U1 accesses the specific room of the shop search site 5a, the other user U2 enters the room by inputting the password.

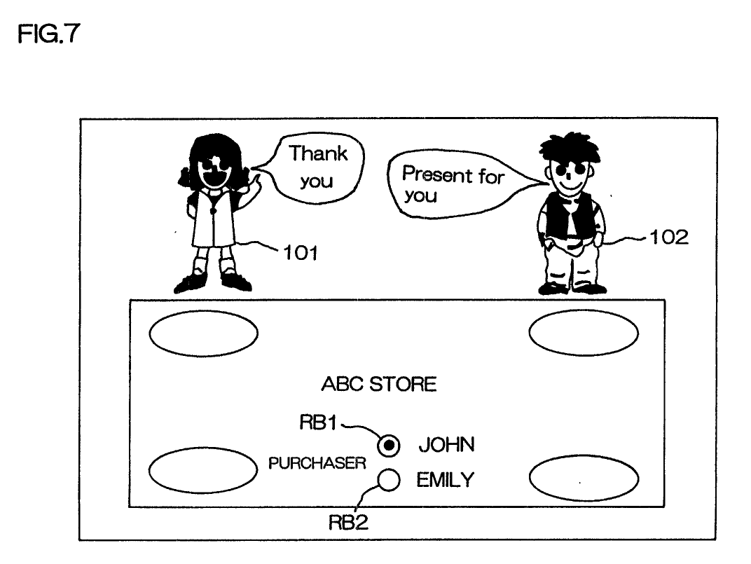

Then, the users set one of them as the purchaser (step S2 of FIG. 4). FIG. 7 shows the Web site of the shop search site 5a and a manner of choosing the purchaser. The shop search site 5a has a chat function. The two users have a conversation with each other with character information through avatars 101 and 102 which are characters representing the users on the site. In doing this, the text data input by the users from their respective user terminals 7 is transmitted to the server 5. The server 5 creates screen data where the text data is shown in the balloons representing what the avatars are saying, and transmits the screen data to both of the user terminals 7. On the user terminals 7, the screen data is displayed.

That is, the server 5 controls the display on the user terminals so that the same screen is displayed on the user terminals 7 during the chat. The server 5 performs display control so that the same screen is always displayed on the user terminals 7 also in the shop search processing described below.

After accessing the shop search site 5a, the two users choose one of them as the purchaser while chatting. In this embodiment, the purchaser is chosen by inverting either a radio button RB1 or RB2 in the purchaser box in which the users' preset chat names (John and Emily in the example of FIG. 7) are displayed. Consequently, the user not chosen as the purchaser is chosen as a receiver who receives the product without making a payment. The purchaser information is transmitted to the server 5, and the purchaser and the receiver are set on the server 5.

Then, the server 5 acquires the position information of the receiver's user terminal 7 from the receiver's user terminal 7 (step S3 of FIG. 4). Specifically, the server 5 transmits a position information request signal to the receiver's user terminal 7, and receiving the signal, the receiver's user terminal 7 transmits the position information.

Here, the position information is information for identifying the location where the user terminal 7 is physically placed, specifically, the address. When the user terminal 7 is a personal computer placed in a home, since the user terminal 7 is not moved, the position information is as follows: In a case where the user has signed up for the provider possessing the server 5 and the shop search site 5a, the position information is information identifying the user terminal 7 on the Net such as the user identification (ID), the password, the IP address (when the user terminal 7 has one) for the provider. This is because, since the user's name and address have already been registered with the server 5 in the case where the user has signed up for the provider possessing the server 5, the address can be obtained based on the user ID, the password, the IP address and the like acquired as the position information by the server 5.

In a case where the user has not signed up for the provider, the user previously registers his name and address by inputting them from the operation input portion 73 when accessing the shop search site 5a. By doing this, the server 5 can acquire the position information of the user terminal.

In a case where the user terminal 7 is a portable terminal such as a PDA, some of such terminals have a GPS function. In such a case, the position information is coordinate information obtained by the position information acquisition portion 75 (GPS device) shown in FIG. 1, specifically, information on the latitude and the longitude. The server 5 obtains the address of the user terminal 7 from the coordinate information.

As described above, the server 5 obtains the address of the location of the user terminal 7 (the location of the user) from the position information obtained from the user terminal 7, and uses it as a criterion for the shop search as described later.

Then, the users specify the kind of the shop handling the product which they want to purchase, for example, a flower shop or a bookstore by chat (step S4 of FIG. 4). Then, the kind of the shop is stored in the RAM 53 of the server 5.

Then, the users are prompted to input whether to perform a chain store search or not, and when the users input it, whether to perform a chain store search or not is determined (step S5 of FIG. 4). When a chain store search is not specified, a non-chain-store-type shop search is performed (step S6 of FIG. 4). That is, in this embodiment, in addition to a search for a non-chain-store-type shop in the nationhood of the receiver user, a search for chain stores, in the neighborhood of both of the user terminals 7, of a chain having chain stores in various parts of the country can be performed.

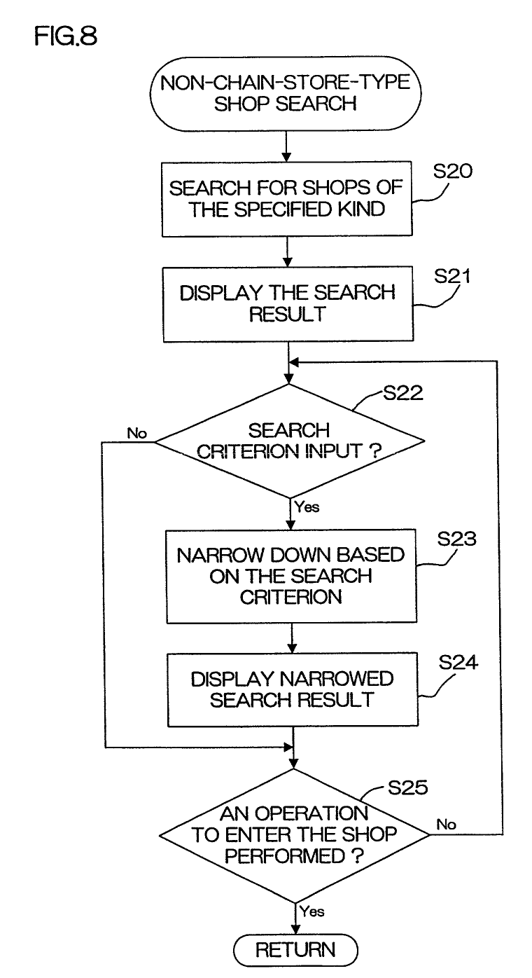

FIG. 8 is a flowchart of the non-chain-store-type shop search processing. Details of the non-chain-store-type shop search processing will be described with reference to FIG. 8. First, shops of the specified kind are searched for (step S20 of FIG. 8). When the number of shops of the specified kind is larger than a predetermined number that can be displayed on one screen (for example, 10), only the predetermined number of shops are displayed and the other shops are displayed by a predetermined operation (for example, clicking on a next candidate button). This display configuration is also used for displaying narrowed search results described later.

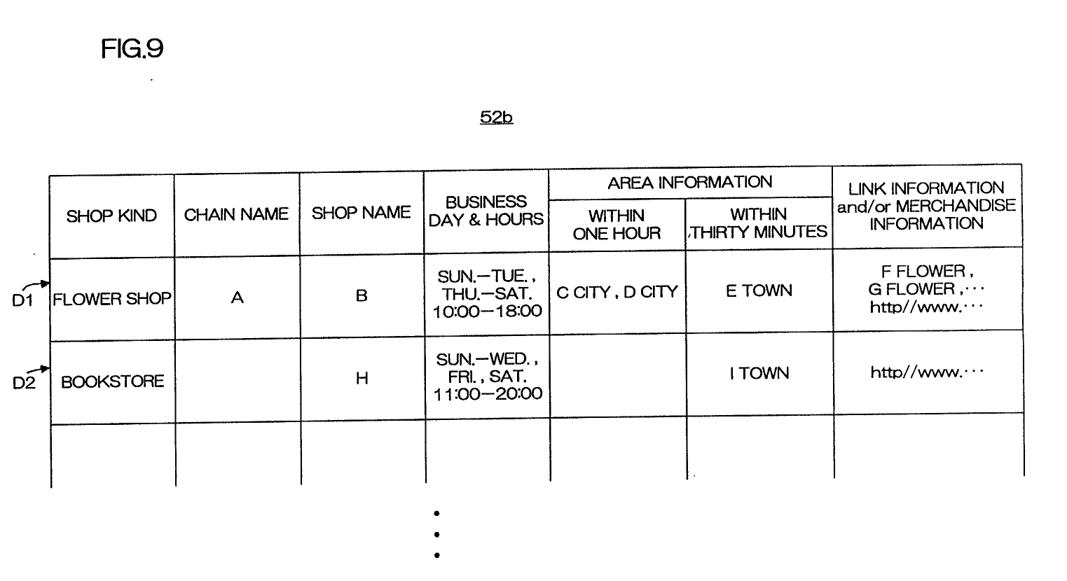

FIG. 9 shows the data format of the shop information database 52b. Each of shop data D1, shop data D2, . . . in the shop information database 52b has a data format such that data items such as the shop kind, the chain name, the shop name, the area information, the business days and hours, the link information and/or the merchandise information constitute one piece of data. The shop in formation database 52b is an aggregate of data in which the above-mentioned data items are provided for each shop. Of the data items, the shop kind, the chain name, the shop name, the area information and the business days and hours are compared with keys to perform a shop search.

Here, the area information represents an area (delivery area) of each shop where delivery can be made within a predetermined time (one hour or thirty minutes). Specifically, the area information is data in which the cities, wards, towns and villages where delivery can be made within the predetermined time are described. The business days and hours represent the business days and the business hours of the shop. The business day and hour item of the shop data is updated by the server 5 accessing the shop terminal 9 at predetermined intervals (for example, every week or everyday), referring to the business day and hour data of the shop terminal 9 and rewriting the content of the business day and hour item of the shop data. The delivery time that is changed according to the busyness of the shop in that month is updated in a similar manner.

In the shop data D1 of the example of FIG. 9, the shop kind is a flower shop, the chain name is A, the shop name is B, and the business days and hours are Sunday through Tuesday and Thursday through Saturday, 10:00 to 18:00. In the area information, the area where delivery can be made within one hour includes C city, D town and E town, and the area where delivery can be made within thirty minutes includes only E town. The shop data further includes the URL of the merchandise purchase page of the shop as the link information. The merchandise purchase page of the shop is provided on the site of the server 5. When the shop data includes chain name data, a list of merchandise handled by the shop is included as the merchandise information. As the merchandise information, for example in the shop data D1, items such as an F flower and a G flower are described.

In the shop data D2, the shop kind is a bookstore, there is no chain name, the shop name is H, and the business days and hours are Sunday through Wednesday, Friday, and Saturday, 11:00 to 20:00. In the area information, the area where delivery can be made within one hour includes only I town. Further, it is shown that delivery can be made within thirty minutes in I town. Since the shop data D2 includes no chain name data, the shop H is not a chain store but a non-chain-store-type shop. In that case, the URL of the site (Web site) of the shop set up on the server 5 (the provider possessing the shop search site 5a) is included as the link information. A multiplicity of such shop data constitutes the shop information data base 52b.

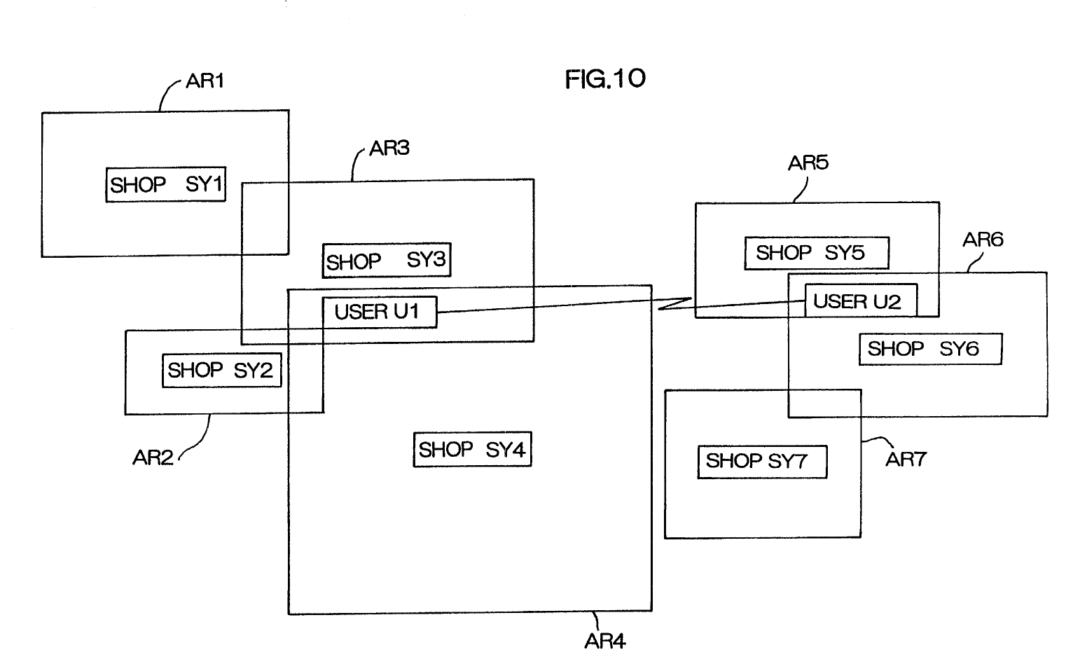

FIG. 10 schematically shows the delivery areas of shops in neighboring areas of the users U1 and U2. In FIG. 10, shops SY1 to SY4 are present in neighboring areas of the user U1. The shops SY1 to SY4 have delivery areas AR1 to AR4, respectively. In neighboring areas of the user U2, shops SY5 to SY7 are present. The shops SY5 to SY7 have delivery areas AR5 to AR7, respectively. Although the delivery areas are rectangular in FIG. 10 because they are schematically shown in the figure, in actuality, the contours of the delivery areas correspond to those of the regions where the shops can make delivery such that the areas are delimited by the boundary line between cities, wards, towns or villages.

At step S20, an AND search is performed by using as the keys both the shop kind specified at step S4 and the city, the ward, the town or the village of the address of the receiver s user terminal 7 identified from the position information. That is, only shops are extracted that include the specified shop kind in the shop kind item of the shop data thereof and include the city, the ward, the town or the village of the address of the receiver's user terminal 7 in the area information item of the shop data thereof. The names of the extracted shops are displayed in list form.

Then, the search result is displayed on both of the user terminals 7 (step S21 of FIG. 8). That is, the server 5 transmits the list of the shop names obtained by the search to both of the user terminals 7 as search result information. Then, the user terminals 7 receive the obtained search result information and display it.

Then, whether a search criterion (narrowing criterion) is input by the users or not is determined (step S22 of FIG. 8). When no search criterion is input, the process proceeds to step S10. When a search criterion is input, the shop search result is narrowed based on the search criterion (step S23 of FIG. 8). The obtained narrowed search result is transmitted to both of the user terminals 7 for the user terminals 7 to display it (step S24 of FIG. 8). Then, whether an operation to enter the shop is performed or not is determined (step S25 of FIG. 8). When an operation to enter the shop is not performed, the process returns to step S22 to repeat the narrowed search and display at steps S22 to S25.

Here, the search criterion is a criterion for narrowing the search. Specifically, the search criterion includes whether immediate delivery (delivery within one hour) is possible or not, whether delivery within thirty minutes is possible or not, whether the shop is open or not and whether the shop is a chain store or not. Of the shop kind, the chain name, the shop name, the area information and the business days and hours of each shop data of the shop information database 52b which items can be used as keys, the items other than the shop kind used first as the search criterion and the chain name that can be used only in the chain store search are used as the narrowing criterion.

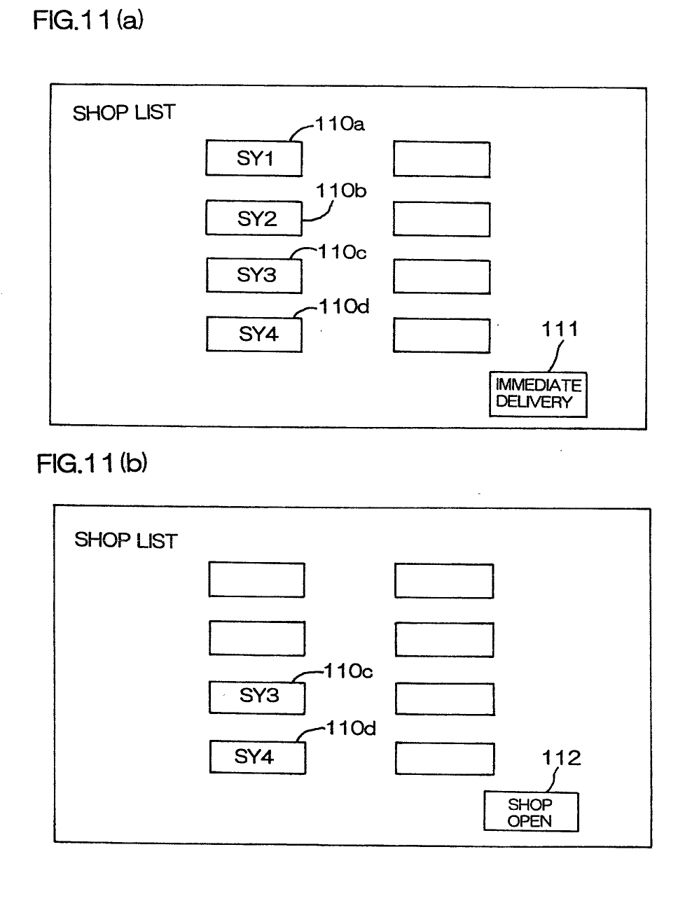

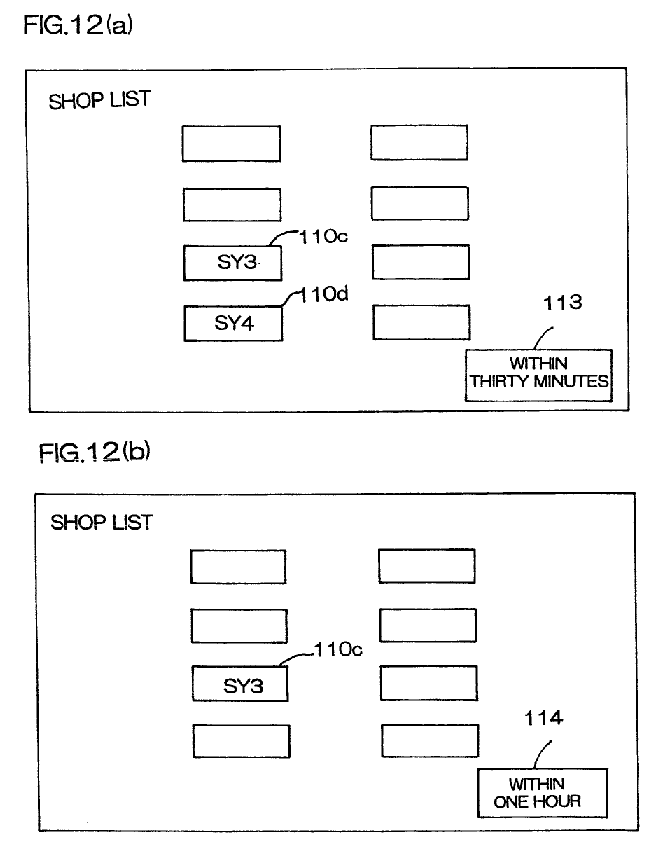

FIG. 11(a) shows the screen before the search is narrowed. FIG. 11(b) shows a narrowed search result screen in a case where the search is narrowed with whether immediate delivery is possible or not as the narrowing criterion. FIGS. 12(a) and 12(b) show narrowed search result screens in a case where the search is further narrowed. FIG. 12(a) shows a result of a search narrowed with whether the shop is open or not as the narrowing criterion. FIG. 12(b) shows a result of a search narrowed with whether immediately delivery is possible or not as the narrowing criterion.

In FIG. 11(a), as the result of a search before narrowing where the shop kind is selected, shop entrance buttons 110a to 110d of the shops SY1 to SY4 are displayed in list form. When an immediate delivery button 111 is clicked on the screen of FIG. 11(a), the server 5 compares the item, of information on the area where delivery can be made within one hour, of each shop data with the city, the ward, the town or the village of the address of the receiver's user terminal 7 obtained from the position information as the key, and displays the list of the shops including the key. The screen of FIG. 11(b) shows the list. That is, the screen of FIG. 11(b) shows that the search result is narrowed to the shops SY3 and SY4 capable of immediate delivery (delivery within one hour).

When a shop open button 112 is clicked in FIG. 11(b), the server 5 refers to the current time, compares the business day and hour item of each shop data with the current time as the key, and displays the list of the shops the business hours of which include the current time. The screen of FIG. 12(a) shows the list. That is, on the screen of FIG. 12(a), of the shops capable of immediate delivery, the currently open shops SY3 and SY4 are displayed. When a within thirty minutes button 113 is clicked in FIG. 12(a), the server 5 compares the item, of information on the area where delivery can be made within thirty minutes, of each shop data with the city, the ward, the town or the village of the address of the receiver's user terminal 7 obtained from the position information as the key, and displays the list of the shops including the key. The screen of FIG. 12(b) shows the list. When a within one hour button 114 is clicked in FIG. 12(b), the screen returns to the one shown in FIG. 12(a).

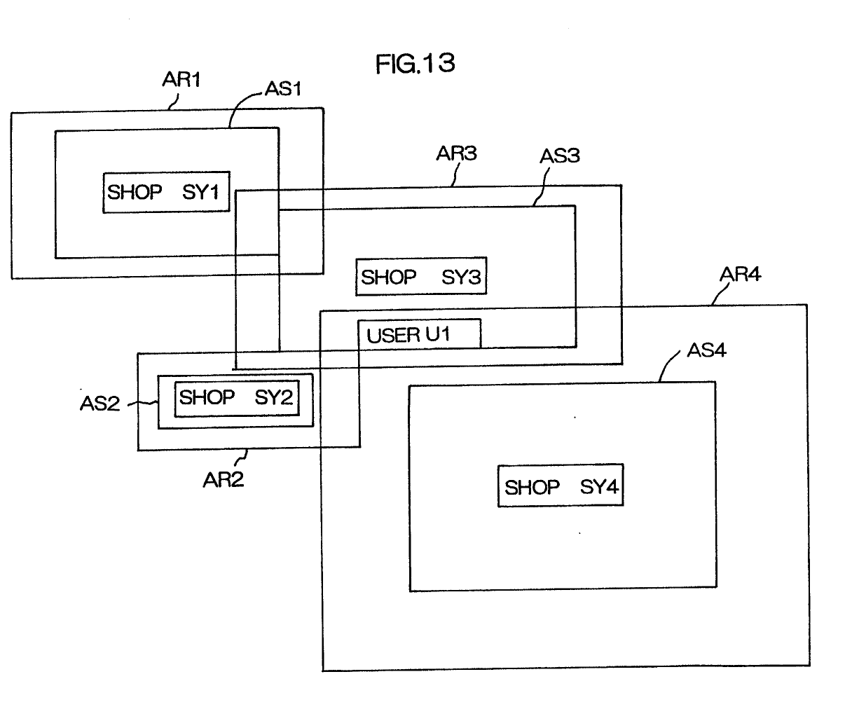

FIG. 13 shows details of the delivery areas of the shops in neighboring areas of the user U1 of FIG. 10. As mentioned above, in this embodiment, delivery areas AS1 to AS4 where delivery can be made within thirty minutes are specified within delivery areas AR1 to AR4 (the delivery areas AR1 to AR4 of FIG. 10) where delivery can be made within one hour. Since the shop of which area where delivery can be made within thirty minutes includes the user U1 is only the shop SY3 in FIG. 13, only the shop SY3 is displayed in FIG. 12(b).

Returning to FIG. 4, when it is determined at step S25 of FIG. 7 that an operation to enter the shop is performed, the screen moves to the site of the shop. Specifically, on the search result information display screens as shown in FIGS. 11 and 12, the shop names displayed in list form are the shop entrance buttons 110a to 110d for entering the shops as mentioned above. Then, when the user U1 or U2 clicks on one of the shop entrance buttons with one of the shop names on it on the user terminal 7, the server 5 refers to the link information item of the shop data of the shop, and causes both of the user terminals to display the Web site of the shop.

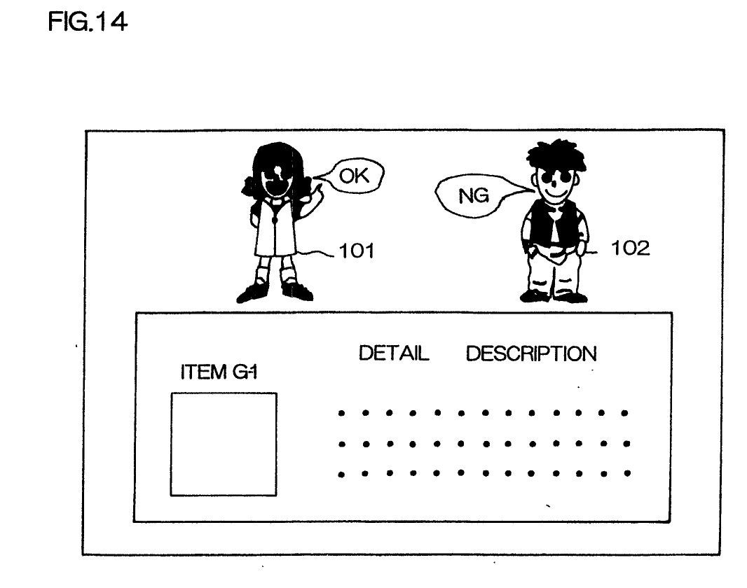

FIG. 14 shows the Web site of the shop. As shown in FIG. 14, in displaying the sites of the shops provided on the server 5, the same contents are displayed on both of the user terminals 7 as described above. The sites have a chat function as mentioned above.

On the Web site of each shop, a list of merchandise handled by the shop is displayed. When one of the displayed products is selected, a detailed description of the product is shown like in FIG. 14. The product cannot be purchased until both users agree to purchase it in a conversation by chat under this condition. A keyword representing an intension to purchase (“OK” in FIG. 14) and a keyword representing an objection to purchase (“NG” in FIG. 14) are prespecified. The server 5 imposes a restriction so that the screen moves to the purchase screen only when the specified keyword representing an intension to purchase is transmitted from both of the user terminals 7. The above described is the non-chain-store-type shop search processing.

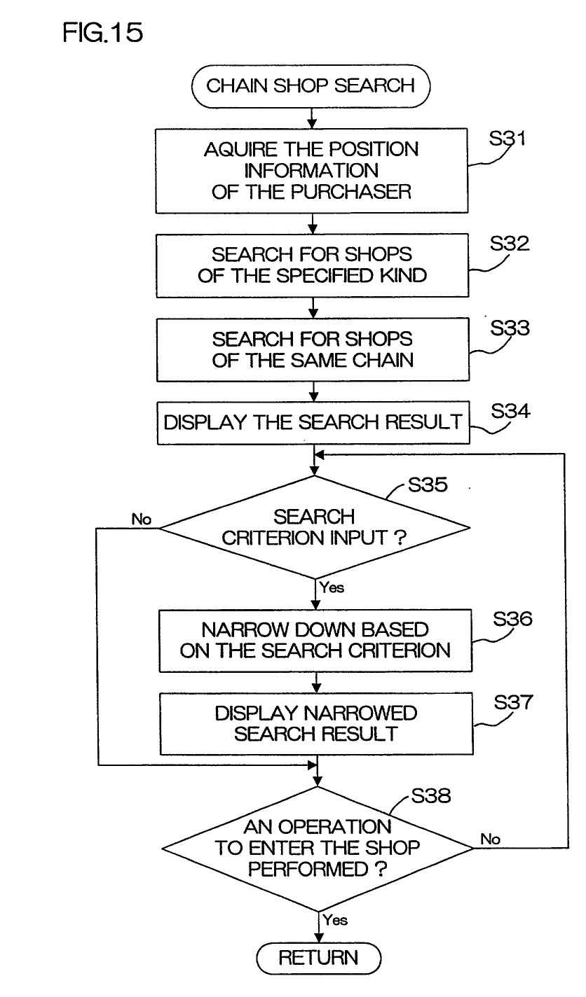

When a chain store search is specified at step S5 of FIG. 4, a chain store search is performed (step S8 of FIG. 4). FIG. 15 is a flowchart of the chain store search processing. First, the position information of the purchaser user is acquired (step S31 of FIG. 15). The position information of the purchaser user is acquired because in the chain store search, the same product as that delivered to the receiver user is delivered to the purchaser user as described later. This is also because the purchaser user's address is also necessary when shops of the same chain in neighboring areas of the user terminals 7 are searched for.

Then, a search based on the shop kind is performed (step S32 of FIG. 15). Specifically, a search is performed with the shop kind as the key. That is, only the shops including the specified shop kind in the shop kind item of the shop data thereof are extracted, and the names of the shops are displayed in list form.

Then, a search for shops of the same chain the delivery areas of which include the receiver user and the purchaser user is performed (step S33 of FIG. 15). Specifically, a search with the city, the ward, the town or the village of the receiver user's address as the key is performed. Further, by referring to the chain name item of the retrieved shop data, shops the data items of which include a chain name are retrieved. Likewise, a search with the city, the ward, the town or the village of the purchaser user's address as the key is performed. Then, by referring to the chain name item of the retrieved shop data, shops the data items of which include a chain name are retrieved. Lastly, by comparing the chain name items of the shop data of the retrieved two groups of shops, only shops including the same chain name in the chain name items of the shop data thereof are extracted and displayed in list form. As is apparent from this search method, chain stores of a specific chain are extracted not only in a case where the purchaser user side chain store of the chain and the receiver user side chain store of the chain are different but also in a case where the purchaser user side chain store of the chain and the receiver user side chain store of the chain are the same.

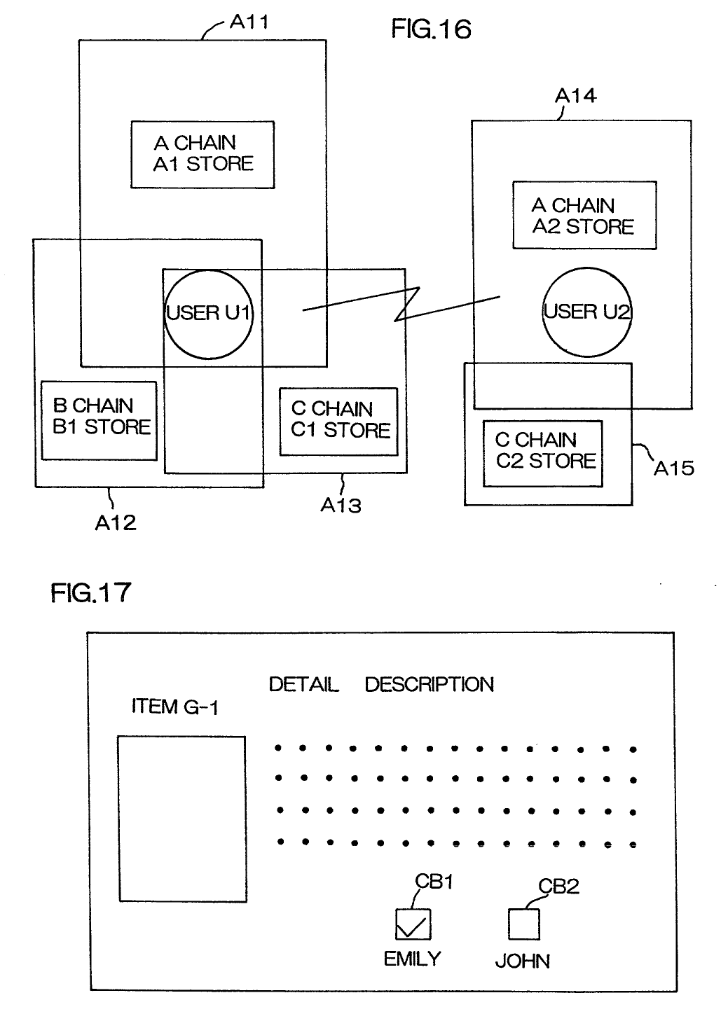

FIG. 16 schematically shows the delivery areas of shops of the same chains in neighboring areas of both of the user terminals 7. In FIG. 16, in neighboring areas of the user U1, A1 store of A chain, B1 store of B chain and C1 store of C chain have delivery areas A11 to A13 where delivery can be made within one hour. The delivery areas A11 to A13 all include the user U1. In neighboring areas of the user U2, A2 store of A chain and C2 store of C chain have delivery areas A14 and A15. The delivery area A14 includes the user U2. Therefore, in this case, the search result is A1 store of A chain and A2 store of A chain.

Then, the search result is displayed on both of the user terminals 7 like at step S21 of FIG. 8 (step S34 of FIG. 15). On the list of shops of the same chain thus obtained, processings similar to the narrowed search, the display and the determination as to whether an operation to enter the shop is performed or not in the non-chain-store-type shop search (steps S22 to S25 of FIG. 8) are performed (steps S35 to S38 of FIG. 15).

Returning to FIG. 14, when an operation to enter the shop is performed, the merchandise list is displayed on both of the user terminals 7 (step S9 of FIG. 4). In that case, when the shops on the sides of the user terminals 7 are different chain stores of the same chain, only the products handled by both of the shops are selectively displayed. That is, the merchandise information items of the shop data of the shops are compared, and only the common products are displayed in list form.

The display format of the merchandise list in this case is substantially similar to that of FIG. 4. That is, the same contents are displayed on both of the user terminals 7 as described above, and a chat function as mentioned above is provided. However, in this stage, a merchandise list obtained by referring to the merchandise information of the shop data is displayed. The merchandise purchase in the chain store search is similar to that in the non-chain-store-type shop search in that a product cannot be purchased until both of the users agree to purchase it in a conversation by chat like FIG. 14. However, it is different from the example of FIG. 14 in that by referring to the link information of the shop data of the purchaser user side shop in a merchandise purchase operation, the merchandise purchase page of the site of the shop is displayed.

Then, by the users' merchandise purchase operation in a non-chain-store-type shop or by the users' merchandise purchase operation in a chain store, a merchandise purchase processing is performed on a non-illustrated merchandise purchase page (step S10 of FIG. 4). Then, the product can be purchased by a predetermined operation on the purchase screen. In the case of the chain store search, to the purchaser user, the purchased product is delivered from the purchaser user side chain store of the chain, and to the receiver user, the same product as the purchased product is delivered from the receiver user side chain store of the chain. In that case, information that the same product is purchased and that the product is to be delivered to the receiver user of the chain is transmitted from the purchaser user side chain store of the chain to the receiver user side chain store of the chain.

In that case, the payment for both users' purchases is made by electronic banking by the purchaser user. The above described is the shop search processing and the online shopping processing accompanying it.

As described above, in a virtual date, it is possible for one person to immediately give a product as a gift to the other person at a remote location by an immediately delivery, or to have the same product as his purchase delivered to the other person.

In this embodiment, the server 5 realizes the following display control method: In response to reception of instruction information (search criterion) from a second user terminal (the purchaser's user terminal 7), the server 5 receives first information (position information) from a first user terminal (receiver's user terminal 7), processes second information (shop information database 52b) stored in the server 5 based on the first information to obtain processed information (shop list), and transmits the processed information at least to the first user terminal for the terminal to display it.

As described above, since a search for shops the delivery areas of which include the receiver's user terminal 7 (first user terminal) is performed based on the position information of the receiver's user terminal 7 and the obtained search result information is transmitted to the receiver's user terminal 7, the shops having predetermined delivery areas including the receiver's user terminal 7 are easily retrieved.

Moreover, since the same search result is displayed on the purchaser's user terminal 7 (second user terminal) different from the receiver's user terminal 7, the receiver user and the purchaser user can share the same shop search result.

Moreover, since a narrowed search to select only shops meeting a narrowing criterion can be performed on the shops included in the shop list, the shop list is hierarchically displayed according to the search criterion.

Moreover, since the delivery time can be specified as a search criterion, a shop having a desired delivery time can be selected.

Moreover, since the shop names included in the shop list in the non-chain-store-type shop search are linked to the sites of the shops, by selecting a desired shop from the list, the site of the shop can be easily accessed.

Moreover, in the chain store search, since chain stores of the same chain the delivery areas of which include the receiver's user terminal 7 and the purchaser's user terminal 7 are searched for, a chain that can be used by both the receiver user and the purchaser user is retrieved.

Further, in the chain store search, since the list of only the products handled by both of different chain stores of a chain is transmitted to both of the user terminals 7, the users can obtain a common merchandise list.

<3. Modification>

While examples of the shop search system, the shop search method and the display control method are shown in the above-described embodiment, the present invention is not limited thereto.

For example, in the above-described embodiment, a case is shown where a pair of a man and a woman search for a shop on a shop search site and purchase a product. However, the pair may be a pair of men or women. Further, the shop search site may be one where a group of three or more users can shop. In that case, in the non-chain-store-type shop search, search is made based on the position information of the receiver, and in the chain store search, search is performed based on the position information of all the persons. Moreover, a search result of the same content is displayed on each user terminal.

FIG. 17 shows a modification of the user terminal screen in online shopping. In the example of FIG. 17, no chat is performed, and instead, checkboxes CB1 and CB2 with which the users can input whether they want to purchase a product or not are provided. When a user wants to purchase a product, he places a checkmark in his checkbox, and when a user does not want to purchase a product, he does not place a checkmark in his checkbox. By doing this, a product can be purchased under an agreement reached between the users without performing a chat.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A system for providing communication terminals with information on a shop through communication, said system comprising:
a first storage portion for storing data of a plurality of shops, said data of the shops including delivery area information on delivery areas of the shops;
an acquisition portion for acquiring first location information on a location of a first communication terminal;
a processing portion for searching for a shop a delivery area of which includes the location of the first communication terminal based on the stored delivery area information and the received first location information; and
a transmission portion for transmitting a result of the search by the processing portion to the first communication terminal.

2. A system according to claim 1, wherein the transmission portion transmits the result of the search by the processing portion also to a second communication terminal different from the first communication terminal.

3. A system according to claim 1, wherein the result of the search includes a list of retrieved shops.

4. A system according to claim 3, further comprising a reception portion for receiving from the first communication terminal a narrowing criterion for narrowing the data of the shops, wherein when the reception portion receives the narrowing criterion, the processing portion searches the list of the retrieved shops for a shop meeting the narrowing criterion with reference to the data of the shops, and the transmission portion also transmits a result of the search to the first communication terminal.

5. A system according to claim 4, wherein the delivery area information includes information on an area where the shop can make delivery within a predetermined time.

6. A system according to claim 5, wherein the narrowing criterion relates to the predetermined time.

7. A system according to claim 1, wherein the result of the search by the processing portion includes a list of names of shops delivery areas of which include the location of the first communication terminal, the transmission portion transmits the list to the first communication terminal, and the transmitted names of the shops have link information on links to sites of the shops on a network.

8. A system according to claim 1, wherein the acquisition portion acquires second location information on a location of a second communication terminal different from the first communication terminal.

9. A system according to claim 8, wherein the data of the shops includes, when the shops are chain stores, information for identifying chains to which the shops belong, and the processing portion searches for a shop a delivery area of which includes the location of the first communication terminal and a shop a delivery area of which includes the location of the second communication terminal which shops are chain stores of the same chain based on the stored delivery area information, the information for identifying chains, the acquired first location information and the acquired second location information.

10. A system according to claim 9, wherein the data of the shops includes, when the shops are chain stores, information on merchandise handled by the shops, and the transmission portion transmits a list of merchandise handled by both of the shops to the first communication terminal and the second communication terminal.

11. A system according to claim 1, wherein the first location information is an address of the location of the first communication terminal.

12. A system according to claim 1, wherein the first location information is a longitude and a latitude of the location of the first communication terminal.

13. A system according to claim 1, wherein the acquisition portion acquires the first location information by receiving the first location information transmitted from the first communication terminal.

14. A system according to claim 1, further comprising: a second storage portion in which user information for identifying a user is stored, said user information including location information on a location of the user's communication terminal; and a reception portion that receives information for identifying a first user from the first communication terminal, wherein the acquisition portion acquires the location information of the communication terminal by referring to the user information corresponding to the received information.

15. A method for providing a communication terminal with information on a shop through communication by use of a system in which data of a plurality of shops including delivery area information on delivery areas of the shops is previously stored, said information providing method comprising the steps of:
acquiring location information on a location of the communication terminal;
based on the delivery area information of the shops and the received location information, searching for a shop a delivery area of which includes the location; and
transmitting a result of the search by a processing portion to a first communication terminal.

16. A method according to claim 15, wherein the location information is acquired by receiving the location information from the communication terminal.

17. A method according to claim 15, wherein in the system used, user information for identifying a user and including location information on a location of the user's communication terminal is stored, and the location information of the communication terminal is acquired by receiving the information for identifying the user from the communication terminal and referring to the user information corresponding to the received information.

18. A display control method in which a server to which a first communication terminal and a second communication terminal are connected so that communication can be performed between the server and the terminals controls at least a display portion of the first communication terminal, said display control method comprising the steps of:
receiving an instruction from the second communication terminal;
receiving first information from the first communication terminal in response to reception of the instruction;
processing data stored in the server based on the received first information; and transmitting the processed data at least to the first communication terminal, wherein the first communication terminal displays the received information on the display portion thereof in response to reception of the processed data.

19. A method according to claim 18, wherein the stored data includes data of a plurality of shops, the data includes area information on areas where the shops can make delivery within a predetermined time, the received instruction is on the predetermined time, the received first information is on a location of the first communication terminal, the processed data is a list of shops capable of making delivery to the location of the first communication terminal within the specified predetermined time, and on the first communication terminal, the list of the shops capable of making delivery within the specified predetermined time is displayed.
